(19) United States
(12) Patent Application Publication
(10) Pub. No.: US 2025/0258494 A1
(43) Pub. Date: Aug. 14, 2025

(54) Method for Determining Maximum A Posteriori Estimates of Generalized-Gamma Family Distributions

(71) Applicant: The Boeing Company, Arlington, VA (US)

(72) Inventor: Jacob Edward Faust, Columbia, MO (US)

(21) Appl. No.: 18/440,256

(22) Filed: Feb. 13, 2024

(51) Int. Cl. G05B 23/02

(52) U.S. Cl. CPC G05B 23/0283; G05B 23/024

(57) ABSTRACT

A method of receiving operation data about a collection of machines. The operation data characterizes one or more aspects of the operation of at least one machine of the collection of machines. The method further includes establishing a first conjugate prior or a second conjugate prior for a first distribution probability density function. The method further includes performing, based on the operation data and the first and second conjugate priors for the first distribution probability density function, a Maximum A Posteriori (MAP) estimation to determine distribution parameters for the first distribution probability density function. The data are samples of the key performance indicator. The method further includes predicting, based on the distribution parameters, a probability the key performance indicator will take a value for a number of the machines. In addition, the method includes scheduling maintenance for the machines based on the probability.

### TECHNOLOGICAL FIELD

The present disclosure generally relates to observing and subsequently characterizing fleet operations, emphasizing predicting indicators related to one or more fleet vehicles.

### BACKGROUND

Vehicle fleets are monitored for a wide variety of statistics that are observed or computed known as Key Performance Indicators (KPIs). KPIs are data metrics used to track various aspects of a performance of the fleet, such as but not limited to the safety and performance of the vehicles and the overall fleet. Examples of KPIs include fleet vehicle utilization, vehicle longevity, vehicle reliability, maintenance completion times, fix-effectiveness, customer satisfaction, and customer retention rates. A large amount of data is used to analyze the fleet and forecast the indicators. The data can be obtained in a variety of different manners including, but not limited to, real-time monitoring of the individual vehicles, historic data points from previously recorded flights, and simulated testing. The analysis includes identifying or expressing the data in functions or as discussed herein as statistical distributions. Statistical distributions are mathematical expressions that describe the probability that a random process will take on a specific value or set of values.

There is a need to characterize and analyze large amounts of data to forecast many indicators. The analysis should provide for obtaining meaningful results without requiring high computational power requirements.

Unless explicitly identified as such, no statement herein is admitted as prior art merely by its inclusion in the Technological Field and/or Background section.

### SUMMARY

One aspect of the present disclosure is directed to a method of receiving operation data about a collection of machines. The operation data characterizes one or more aspects of the operation of at least one machine of the collection of machines. The method further includes establishing a first conjugate prior or a second conjugate prior for a first distribution probability density function. The method further includes performing, based on the operation data and the first and second conjugate priors for the first distribution probability density function, a Maximum A Posteriori (MAP) estimation to determine distribution parameters for the first distribution probability density function. The data are samples of the key performance indicator. The method further includes predicting, based on the distribution parameters, a probability the key performance indicator will take a value for a number of the machines. In addition, the method includes scheduling maintenance for the machines based on the probability.

The features, functions, and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an illustration of the methods disclosed herein applied to a fleet management enterprise according to some aspects of the present disclosure.

FIG. 2 illustrates an example of a prior-to-posterior evolution in Bayesian inference.

FIG. 3 is a flow diagram illustrating a method of determining a distribution parameter according to some aspects of the present disclosure.

FIG. 4 illustrates a MAP estimator according to some aspects of the present disclosure.

FIG. 5 is a flowchart of the method of determining a distribution parameter according to some aspects of the present disclosure.

FIG. 6 is a flow diagram for determining the most likely distribution parameter for a generalized-gamma distribution according to some aspects of the present disclosure.

FIG. 7 is a flow diagram for determining the most likely distribution parameter for an Erlang distribution according to some aspects of the present disclosure.

FIG. 8 is a flow diagram for determining the most likely distribution parameter for a chi or chi-squared distribution according to some aspects of the present disclosure.

FIG. 9 is an exemplary computing device for performing the methods disclosed herein.

### DETAILED DESCRIPTION

The present application is directed to analyzing distributions of a collection of machines. A variety of different machines are applicable, including but not limited to various vehicles (e.g., such as aircraft, ships, trucks, cars), manufacturing equipment, computing equipment, and office equipment. One example of a collection is a vehicle fleet. The systems analyze distributions of vehicle fleet data to determine values of parameters of the distribution. These parameters provide for describing and forecasting indicators for the vehicle fleet. More specifically, the analysis includes Maximum A Posteriori estimation via conjugate priors to determine the distribution parameters that are likely occurring for a given distribution given operations of a random data-generating process. The analysis provides for estimating the distribution parameters without using Maximum Likelihood Estimation (MLE) or Monte Carlo methodologies. The present application estimates distribution parameters without the need for extensive computational capacity that is required with Monte Carlo approaches to Bayesian Inference or the larger data needs in MLE.

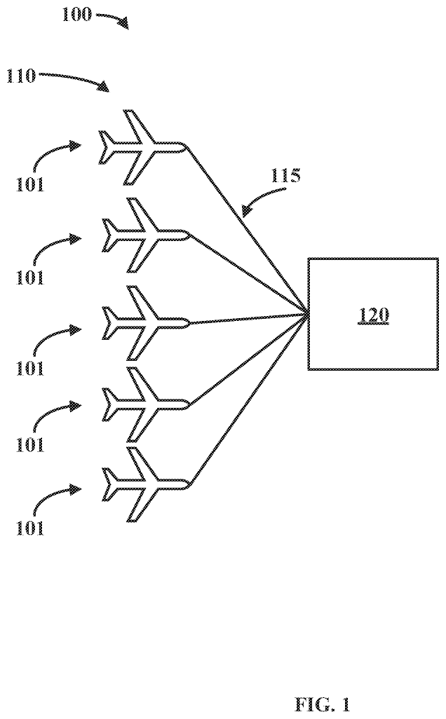

FIG. 1 schematically illustrates a fleet management system 100 that monitors the operation of a vehicle fleet 110. Vehicles 101 are configured to transport passengers and/or cargo or execute missions. The number and type of vehicles 101 that comprise the vehicle fleet 110 can vary. The fleet management system 100 receives data 115 from and about vehicles 101. Examples of data 115 include but are not limited to the number of hours in operation, distance traveled, the amount of cargo, fuel usage, maintenance records, and weather conditions. The data can be collected from a variety of different sources, including but not limited to sensors that are onboard the vehicles 101, flight crew input, and third-party data such as the Federal Aviation Administration, airport authorities, airline personnel, and weather services (e.g., National Weather Service). The fleet management system 100 includes a computing device 120 that receives the data 115.

Computing device 120 analyzes the data 115 and calculates the values of the parameters for a parametric distribution. In some examples, the alpha (a) parameter and/or the beta (β) parameters are calculated for several different distributions (e.g. gamma, Erlang, chi, chi-squared, inverse-gamma, Nakagami). For the generalized gamma family of parametric distributions, alpha (α) describes the shape, and beta (β) describes the rate of the distribution. The computing device 120 determines the most-likely alpha (α) parameter and/or beta (β) parameter that most closely matches the observed distribution of data.

In some examples, alpha (α) parameter and/or beta (β) parameters are calculated by the computing device 120 for the “generalized gamma” distribution family including but not limited to the gamma, Erlang, chi, chi-squared, inverse-gamma, and Nakagami distributions. The analysis is restricted to this family because they have the same “conjugate prior” distributions. A prior distribution is a function that specifies prior beliefs as to where a given set of parametric values belongs (in this case the values are alpha (α) and beta (β)). A conjugate prior is a special prior distribution that, after incorporating information from new data, forms a ‘posterior’ distribution that has the same function as the prior but with augmented hyperparameters.

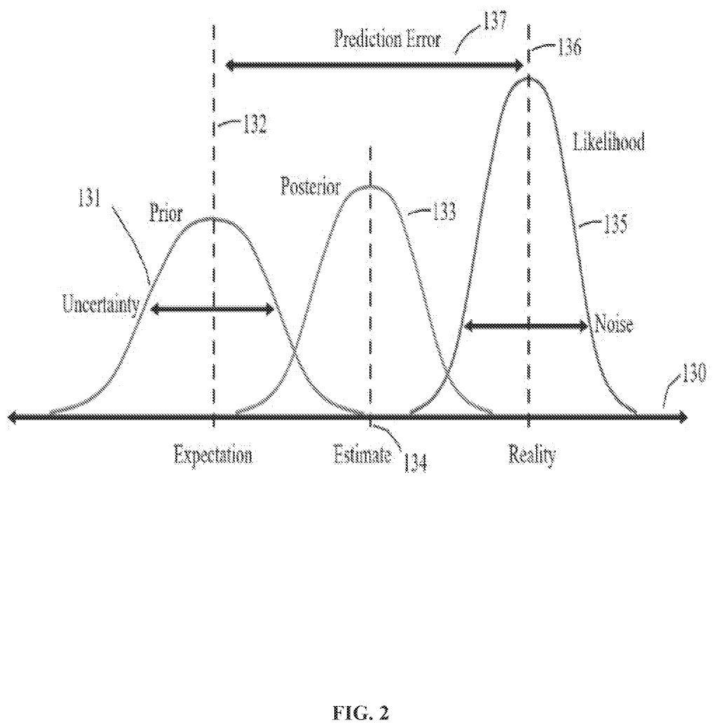

FIG. 2 illustrates an example of a prior-to-posterior evolution. In this example, the abscissa 130 is one of the various values that a parameter could take for a given distribution. In this example, the parameter has a normal distribution with a mean having the highest value on the ordinate. At the beginning of the process, the parameter is believed to have the prior distribution 131 with a mean value 132. When characteristics of samples are used to adjust the prior distribution per Bayes Theorem, the distribution moves along the abscissa 130 to a posterior distribution 133 with an estimated mean value 134. This movement provides for a more accurate prediction of the parameter, which has an actual (reality) distribution 135 with an actual mean value 136. The prediction error 137 is reduced from the original prior expectation and the estimated posterior values.

Existing methods that determine distribution parameters include Maximum Likelihood Estimation (MLE) and Monte Carlo-based Bayesian methods such as Gibbs Sampling. MLE approaches suffer in that they cannot be initialized with prior beliefs. Thus, MLE methods typically require more data to draw a statistical adjudication. Monte Carlo methods can incur heavy computational requirements.

The present application determines the best parameter values for alpha (α) and beta (β). Equation 1 is the probability density function that describes the probability of observing the value x for a generalized-gamma random variable.

$$p ( x \vert α , β , γ ) = \frac{\vert γ \vert {β}^{α} {x}^{γ α - 1}}{Γ ( α )} {e}^{- β {x}^{γ}} \qquad ( Eq . 1 )$$

The calculations assume that the value γ is known (specified a-priori). Further, restrictions are implemented for Erlang, chi, and chi-squared distributions. α is restricted to positive integers for Erlang. For chi-squared and chi, α is restricted to positive integers divided by 2 and β restricted to ½.

The methods disclosed herein reduce computational effort, are faster than conventional methods, and/or require less data for computing distributions for generalized-gamma distributed random variables. The computed distributions may be used in a broad spectrum of real time embedded applications.

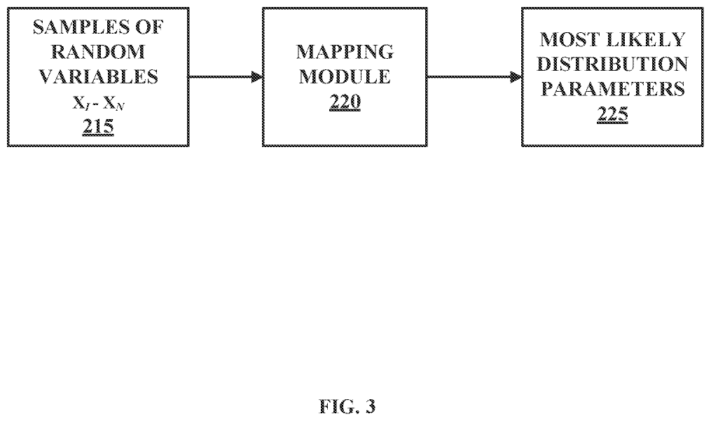

FIG. 3 illustrates a process for determining the most likely parameter values for a given distribution. Samples of the random variable, xᵢ where iϵ{1, 2, . . . , n}, are retrieved (block 215). In some examples, these variables are processed by a mapping module 220 stored at the computing device 120. In some examples, the mapping module includes a Maximum A Posteriori (MAP) estimator. In some examples, xᵢ where iϵ{1, 2, . . . , n} are used as input for the MAP estimator. The MAP estimator determines the most-likely values for α and β for a given class of distributions and the samples xᵢ (block 225). The mapping module 220 takes the operation data xᵢ and calculates a representation of that data using a distribution.

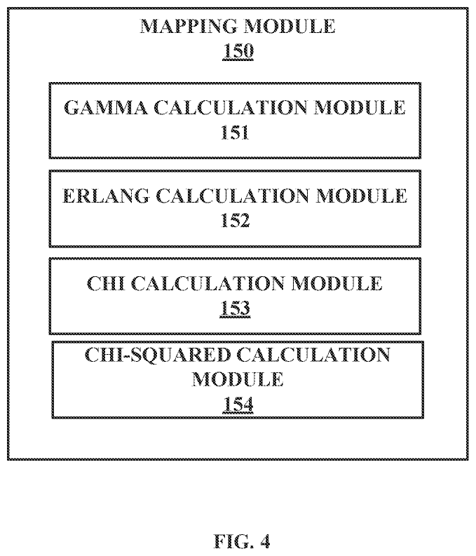

FIG. 4 illustrates an example of mapping module 150. In this example, mapping module 150 is configured to analyze generalized-gamma, Erlang, chi, and chi-squared distributions. Mapping module 150 includes a generalized-gamma calculation module 151, an Erlang calculation module 152, a chi module 153, and a chi-squared module 154. In other examples, the mapping module 150 is configured to analyze additional and/or different distributions. As such, the methods disclosed herein are not limited to the gamma, Erlang, chi, chi-squared, inverse-gamma, and Nakagami distributions.

In the examples used herein, the computing device 120 and mapping module 150 are used by the fleet management system 100 to forecast the operations of a vehicle fleet 110. The mapping module 150 describes characteristics of random processes that generate data. For example, the distribution may describe or suggest the lifespan of vehicle parts across a fleet and/or when to replace the part. Those characteristics are required to make, for example, fleet simulations, and alerting systems.

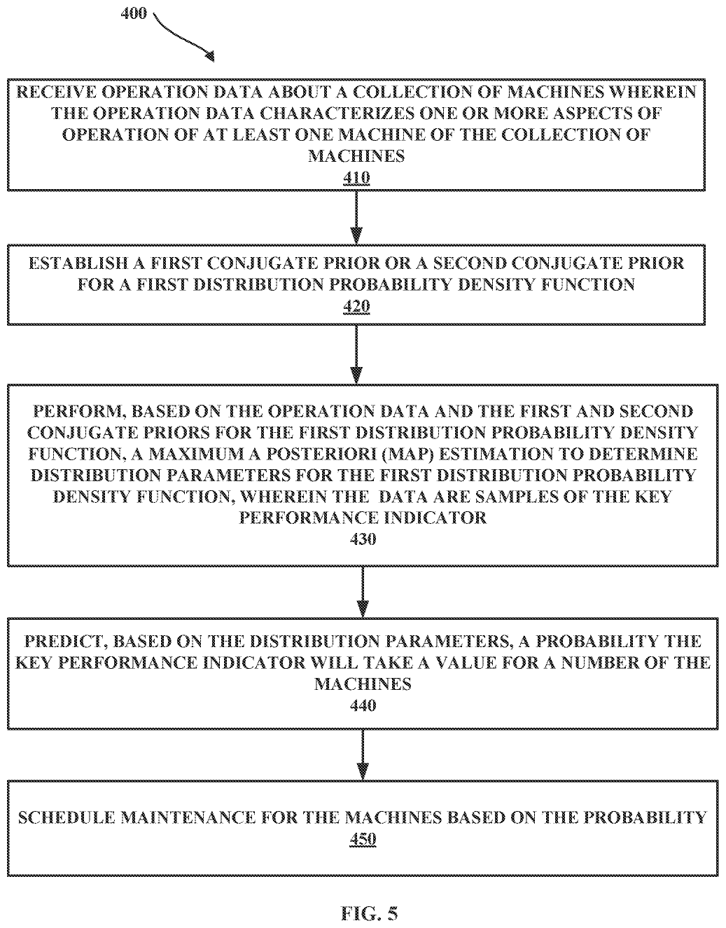

FIG. 5 illustrates a method of analyzing data and including receiving operation data about a collection of machines wherein the operation data characterizes one or more aspects of operation of at least one machine of the collection of machines (block 410). In some examples, the first distribution probability density function is defined within a generalized-gamma distribution family including but not limited to gamma, Erlang, chi, chi-squared, inverse-gamma, or Nakagami distribution function. The method further includes establishing a first conjugate prior or a second conjugate prior for a first distribution probability density function (block 420).

A Bayesian interference is applied to the first distribution probability density function when only a gamma shape distribution parameter, α, is unknown (β and γ are known). In some examples, the first conjugate prior satisfies the following relation with (β, μ) hyperparameters:

$$p ( α \vert δ , μ , β ) ∝ \frac{{( β μ )}^{δ α}}{{Γ ( α )}^{δ}} \qquad ( Eq . 2 )$$

In some examples, the second conjugate prior is defined within a generalized-gamma distribution family. A Bayesian interference is applied to the first distribution probability density function when a gamma shape distribution parameter, α, and a gamma rate distribution parameter, β, are unknown (γ is known). In some examples, the second conjugate prior satisfies the following relation with (δ, η, μ) hyperparameters:

$$p ( α , β \vert δ , η , μ ) ∝ \frac{{( β μ )}^{δ α}}{{e}^{∝ η β} {Γ ( α )}^{δ}} \qquad ( Eq . 3 )$$

The method further includes performing, based on the operation data and the first and second conjugate priors for the first distribution probability density function, a Maximum A Posteriori (MAP) estimation to determine distribution parameters for the first distribution probability density function. The data are samples of the key performance indicator (block 430). The analysis can use various distributions for the first distribution probability density function. Examples include but are not limited to, a gamma distribution probability density function, an Erlang distribution probability density function, a chi distribution probability density function, a chi-squared distribution probability density function, an inverse-gamma distribution probability density function, a chi distribution probability density function, and a Nakagami distribution probability density function.

The method further includes predicting, based on the distribution parameters, a probability the key performance indicator will take a value for a number of the machines (block 440). In some examples related to a fleet management system 100, an indicator can include but is not limited to fleet vehicle utilization, maintenance rates, demand rates, and the time to wear-out life phase for a vehicle 101 or a component of a vehicle 101. In some examples, the indicator is a beginning of a wear-out life phase for a fleet vehicle in the fleet of vehicles. In some examples, the indicator is a repair time to fix a component of the machines.

The method further includes responsive to the predicting, schedule maintenance for machines having a probability of the event associated with the indicator that exceeds a threshold (block 440).

The method further includes scheduling maintenance for the machines based on the probability (450).

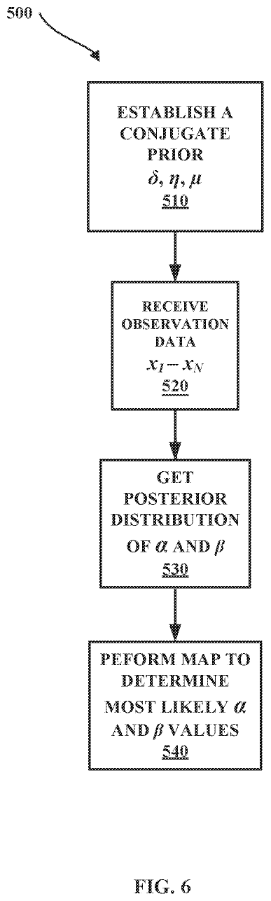

FIG. 6 illustrates a method for determining the most likely distribution parameter for a gamma distribution. Equation (3) is a special case function for determining the most likely (α,β), (i.e. argmax_{(α,β)}(p(α,β|δ, η, μ))=(αₘₐₚ, βₘₐₚ))

At step 510, a conjugate prior is established by specifying values for (δ, η, μ) for the second conjugate prior, Equation (3). A conjugate prior is an algebraic convenience, giving a closed-form expression for the posterior. In this context, (δ, η, μ) are called hyperparameters (parameters of the prior), to distinguish them from parameters of the underlying distribution.

Samples of the random variable x₁, x₂, . . . , xₙ are obtained (block 520). In some examples, the data is retrieved from computing device 120 in real time or from a stored database. A conjugate prior is typically established before samples are collected.

The posterior is established, step 530, using the algebraic convenience/closed-form expression in Equation (5) where x_{α,γ} and x_{g,γ} are defined in Equation (4).

$${x}_{a , γ} := \frac{1}{n} {\sum }_{i = 1}^{n} {x}_{i}^{γ} , and \text{?} {x}_{g , γ} := {( \text{?} {x}_{i}^{γ} )}^{1 / n} \qquad ( Eq . 4 )$$

$${δ}^{′} = δ + n , {η}^{′} = \frac{δ η + {nx}_{a , γ}}{δ + n} , {μ}^{′} = {μ}^{δ / ( δ + n )} {x}_{g , γ}^{n / ( δ + n )} \qquad ( Eq . 5 )$$

$$\text{?} \text{indicates text missing or illegible when filed}$$

At step 540, the mapping module solves a system of equations that the location of the maximum of Equation 3 given fixed/constant posterior hyperparameters (δ′, η′, μ′) using root finding methods. For example, Halley's method can be used to find the most likely (α,β)=(αₘₐₚ, αₘₐₚ) according to Equations (7)-(9).

Initialization:

$${α}_{0} ∈ [ \frac{1}{2 ( ln ( {η}^{′} ) - ln ( {μ}^{′} ) )} , \frac{1}{2 ( ln ( {η}^{′} ) - ln ( {μ}^{′} ) )} ] \qquad ( Eq . 7 )$$

System of Equations:

$$f ( α ) := ln ( α ) - ψ ( α ) + ln ( {μ}^{′} ) - ln ( {η}^{′} ) \qquad ( Eq . 8 )$$

$$β = \frac{α}{{η}^{′}}$$

Halley's Method:

$${α}_{n + 1} = {α}_{n} - \frac{2 f ( {α}_{n} ) {f}^{′} ( {α}_{n} )}{{2 [ {f}^{′} ( {α}_{n} ) ]}^{2} - f ( {α}_{n} ) {f}^{″} ( {α}_{n} )} \qquad ( Eq . 9 )$$

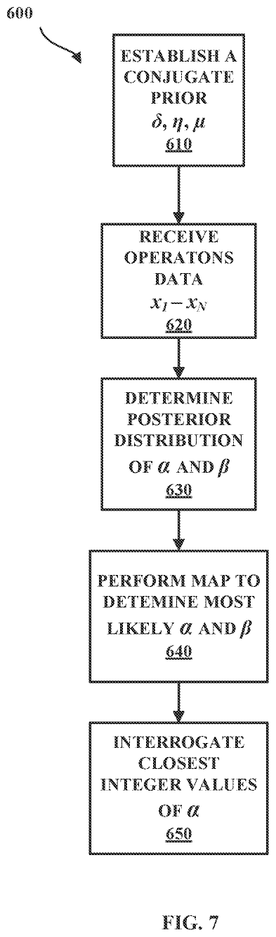

FIG. 7 is a flow diagram for determining the most likely distribution parameter for an Erlang distribution when a gamma shape distribution parameter (α) and rate distribution parameter (β) are unknown. Equation (10) is the Erlang probability density function, a special case of the generalized-gamma distribution (i.e., Equation (1)):

$$p ( x \vert k , λ ) = \frac{{λ}^{k} {x}^{k - 1}}{Γ ( k )} {e}^{- λ k} \qquad ( Eq . 10 )$$

Steps 610, 620, 630, and 650 are similar to that of the generalized-gamma distribution except that, among other things, method 600 includes an additional interrogation step 640 to determine the closest integer values of α to αₘₐₚ using Equation 11:

$$( {k}_{MAP} , {λ}_{MAP} ) = {arg max}_{( α , β ) ∈ A} p ( α , β \vert {δ}^{′} , {η}^{′} , {μ}^{′} ) \qquad ( Eq . 11 )$$

$$where A := \{ ( ⌊ {α}_{MAP} ⌋ , \frac{⌊ {α}_{MAP} ⌋}{{η}^{′}} ) \text{?} ( ⌊ {α}_{MAP} ⌋ , \frac{⌊ {α}_{MAP} ⌋}{{η}^{′}} ) \}$$

$$\text{?} \text{indicates text missing or illegible when filed}$$

In addition, the most likely parameter values are represented as k and λ values where (k, λ)=(kₘₐₚ, λₘₐₚ).

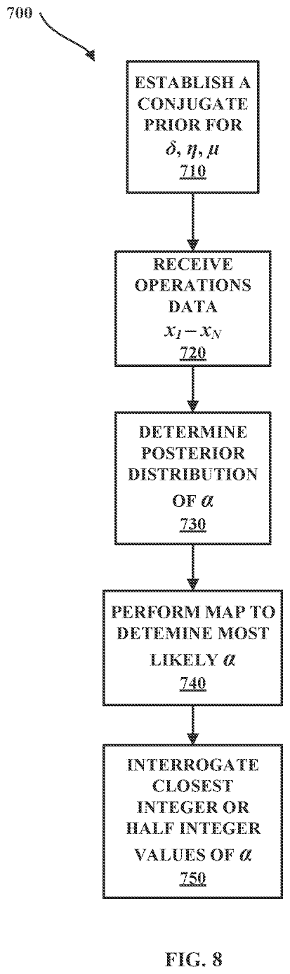

FIG. 8 is a flow diagram for determining the most likely distribution parameter for a chi distribution when the degrees of freedom parameter, k, is unknown. Equation (12) is the probability density function of the chi distribution, a special case of the generalized gamma distribution.

$$p ( x \vert k ) = \frac{{x}^{k - 1}}{{2}^{( k / 2 ) - 1} Γ ( k / 2 )} {e}^{- {x}^{2} / 2} \qquad ( Eq . 12 )$$

Analogously, a chi-squared distribution would apply the same method as for the chi distribution except that the value γ is equal to 1. Equation (13) is the probability density function of the chi-squared distribution.

$$p ( x \vert k ) = \frac{{x}^{k / 2 - 1}}{{2}^{k / 2} Γ ( k / 2 )} {e}^{- x / 2} \qquad ( Eq . 13 )$$

Similar to the Erlang distribution, steps 710, 720, and 730 follow the same process as the Generalized-gamma distribution but with the first conjugate prior (as β is known and equal to ½ in this case). An additional interrogation step 750 is required to determine the closest positive integer or half-integer values of α to αₘₐₚ. This value is equivalent to k/2.

At step 740 the mapping module solves a system of equations, that use hyperparameters, (δ′, μ′), as constants, using root finding methods. For example, Halley's method can be used to find the most likely α (αₘₐₚ) according to Equations (14)-(16).

$${α}_{0} ∈ [ \frac{{μ}^{′} + 1}{2} , \frac{1}{ln ( \frac{2}{{μ}^{′}} + 1 )} ] \qquad ( Eq . 14 ) initialization$$

$$f ( α ) := ψ ( α ) - ln ( {μ}^{′} / 2 ) \qquad ( Eq . 15 ) System of Equations$$

$${α}_{n + 1} = {α}_{n} - \frac{2 f ( {α}_{n} ) {f}^{′} ( {α}_{n} )}{{2 [ {f}^{′} ( {α}_{n} ) ]}^{2} - f ( {α}_{n} ) {f}^{″} ( {α}_{n} )} \qquad ( Eq . 16 ) Halley ’ s Method$$

Once the most likely α is determined (αₘₐₚ), the computing device interrogates the closest integer or half-integer values of a near αₘₐₚ to determine the most likely k=kₘₐₚ using equation 17.

$${k}_{MAP} = 2 ( {arg max}_{α ∈ \{ \frac{⌊ 2 {α}_{MAP} ⌋}{2} , \frac{⌊ 2 {α}_{MAP} ⌋}{2} \}} p ( α \vert {δ}^{′} , {μ}^{′} ) ) \qquad ( Eq . 17 )$$

The various processes receive operational data about a collection of machines. This operational data characterizes one or more aspects of operation of at least one of the machines of the collection. The processes analyze the data to determine distribution parameters that characterize a key performance indicator. Based on the distribution parameters, predictions can be made for the value the key performance indicator for the machines. Using these predictions, maintenance is scheduled for the machines.

For example, the processes are used to initiate service for a group of machines. Each of the machines includes a widget. Operational data about the machines are received and analyzed and distribution parameters are determined. The indicator is the time to an event occurring on the machines that will require maintenance for the widget on the machine. Based on the distribution parameters, maintenance is scheduled for the machines on the widgets when a measure of the key performance indicator exceeds a threshold. One advantage of these processes is maintenance for a large number of machines can be scheduled proactively instead of waiting for an issue to occur with the widget of each machine. Further, the maintenance can be scheduled at a time that will minimize downtime for the machine and to increase the productivity of the machine and the overall group. The processes further provide for analyzing a relatively large amount of operational data for the group without the need for high computational capacity.

For example, operation data can be safety or performance related. Further to the examples outlined herein, the event can be a failure of a component of a machine or inefficient operation of the machine. The operation data may characterize utilization of each of the machines, reliability of each of the machines, hours of operation of each of the machines, fuel or power usage of each of the machines, or the rate of created maintenance records for each of the machines. In some examples, the operation data can indicate a deterioration in the performance of the machines. Additionally or alternatively in the examples, the operation data can indicate increasing vibrations sensed in the machines, or increasing fuel or power usage. The operation data can optionally be provided by sensors of the machines. In some examples, the sensors are health and usage monitoring sensors, strain sensors, vibration sensors, impact sensors, wear sensors, or corrosion sensors.

In some examples, the maintenance can comprise any of inspection of the machine, repair of the machine, and/or retirement of the machine. Optionally, the machines scheduled for maintenance can be prioritized according to how much a measure of the key performance indicator exceeds the threshold. For an example, the collection of machines can be a fleet of vehicles, the fleet may comprise one or more fleet vehicles. In some examples provided herein, the operation data can characterize the distance traveled by each of the vehicles and/or time in operation by each of the vehicles. In some examples, the fleet of vehicles can be a fleet of aircraft or can be ground-based vehicles (e.g., wheeled or track-based vehicles).

In some examples described above, scheduling maintenance of one or more machines (e.g., a fleet) and/or maintaining a collection of machines is performed according to the schedule. An indicator can be or is a beginning of a wear-out life phase for a fleet vehicle in a fleet of vehicles.

In some examples, the indicator is a repair time to fix a component of the machines.

In some examples, the operation data are safety or performance related. Monitoring this data can provide for the machines to be maintained or operated in a manner to ensure safe operation and/or safe usage. Performance-related aspects provide for benefits including but not limited to more efficient use, longer lifespan, and proper maintenance scheduling. Examples include but are not limited to fleet vehicle utilization, vehicle longevity, vehicle reliability, maintenance completion times, fix-effectiveness, customer satisfaction, and customer retention rates.

In some examples, the event is a failure of a component of a machine or inefficient operation of the machine. Monitoring these aspects provides for maintenance of the machine prior to having operational or efficiency issues. Additionally or alternatively, affected machines can be removed from use prior to reaching failure. This provides for more efficient use of the vehicle and safe and efficient operation.

In some examples, the operation data characterize utilization of each of the machines, reliability of each of the machines, hours of operation of each of the machines, fuel or power or usage of each of the machines. This operational data can be used to optimize efficiency of the vehicles and fleet and ensure proper operation of the vehicles. Use of this information can provide for removing vehicles from the fleet prior to experiencing performance issues.

In some examples, the operation data indicate a deterioration in the performance of the machines. Monitoring this operation data provides for more efficient use of the machine and the overall fleet. Further, this operation data can prolong the life of the vehicle as maintenance can be performed prior to damage being done to the machine due to deterioration. Additionally or alternatively, affected machines can be removed from use prior to deteriorating beyond a threshold. In some examples, this provides for more efficient use of the vehicle and safe operation.

In some examples, the operation data indicate increasing vibrations sensed in the machines or increase fuel or power usage. This operation data can be an indicator of future issues with the machine. Monitoring this data can provide for removing the vehicle and providing maintenance prior to reaching a stage of use that could cause damage to the machine and/or inefficient use of the machine. Vibrations and increased fuel or power usage have been determined to be indicators of approaching issues with a machine. In some examples, machines are removed to provide a more comfortable ride for a passenger.

In some examples, the operation data are provided by sensors of the machines. The sensors are configured and positioned to provide accurate data that is necessary for an accurate analysis. Monitoring aspects are not effective when the underlying data is not an accurate reflection of the actual aspects of the machines. In some examples, the sensors are health and usage monitoring sensors. These sensors indicate the usage of the vehicles to monitor operational aspects and ensure operation within an expected range. In some examples, the sensors are strain sensors, vibration sensors, impact sensors, wear sensors, or corrosion sensors. These types of sensors provide accurate data about a range of aspects that can be monitored and analyzed. This type of data has been determined to be an effective indicator of future issues when the data exceeds certain thresholds.

In some examples, the maintenance comprises any of inspection of the machine, repair of the machine, or retirement of the machine. The maintenance aspects of the machine provide insightful data that provides accurate and useful output. Issues that have affected the machine provide valuable data that can determine future operational aspects about the other machines and fleet.

In some examples, the machines scheduled for maintenance are prioritized according to how much the indicator exceeds the threshold. In some examples, it has been found that the indicator provides an accurate estimate of when maintenance is due. The farther beyond the indicator that the machine continues to operate the more likely the machine is to have an issue with operation.

In some examples, the collection of machines is a fleet of vehicles. Vehicles can be monitored for a variety of operation data that is used to indicator future operation aspects of the vehicles.

In some examples, the operation data characterizes the distance traveled by each of the vehicles and/or the time in operation of each of the vehicles. These aspects provide a good indication of expected future operation of the vehicle. For example, the greater the number of miles traveled and/or hours flown by an aircraft is an effective indicator of when maintenance is needed to ensure the aircraft continues to effectively operate. In some examples, thresholds are set for distance and/or time in operation and vehicles are removed from service for maintenance once the thresholds have been reached.

In some examples, the fleet of vehicles is a fleet of aircraft. Operational data can be obtained for aircraft that have been found to be effective in predicting how an aircraft and a fleet of aircraft will operate in the future. In some examples, maintenance work can be scheduled and/or performed for aircraft based on the monitored operation data.

In some examples, the methodologies are used to schedule maintenance and maintain a collection of machines according to the schedule. The operational data indicates the expected operation of the machines. Based on the one or more indicators, maintenance of the machines is scheduled to maintain the vehicles in operational condition and maintain or increase the efficiency of the machine and/or fleet. Once the schedule is determined for one or more machines, the machines are monitored and operated according to the schedule. In some examples, following the schedule increases the overall efficiency of the machine and overall fleet of machines.

In some examples, the indicator is a beginning of wear-out life phase for a fleet vehicle in a vehicle fleet. A vehicle that is being monitored can be determined to hit a particular indicator indicating a stage of life towards wear-out. The vehicle can be operated according to the wear-out life phase, such as more frequent maintenance, different maintenance, or no maintenance. This can provide for one or more of increase overall efficiency of the vehicle or more cost-effective operation of the vehicle.

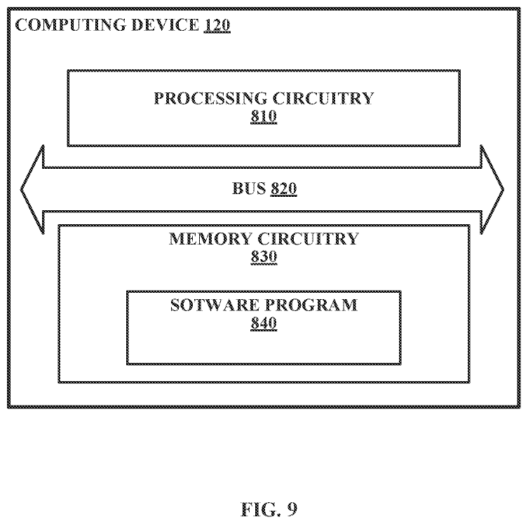

FIG. 9 is a schematic block diagram that illustrates an exemplary computing device 120 according to one or more aspects of the present disclosure. The example computing device 120 includes processing circuitry 810 (i.e., hardware processor) and a memory circuitry 830. The processing circuitry 810 is communicatively coupled to the memory circuitry 830 e.g., via one or more buses 820 the memory contains instructions executable by the computing device 120. The processing circuitry 810 may include one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 810 may be programmable hardware capable of executing software instructions 840 stored, e.g., as a machine-readable computer program in the memory circuitry 830. The memory circuitry 830 of the various aspects may include any non-transitory machine-readable media known in the art or that may be developed, whether volatile or non-volatile, including but not limited to solid state media (e.g., SRAM, DRAM, DDRAM, ROM, PROM, EPROM, flash memory, solid-state drive, etc.), removable storage devices (e.g., Secure Digital (SD) card, miniSD card, microSD card, memory stick, thumb drive, Universal serial bus (USB) flash drive, ROM cartridge, Universal Media Disc), fixed drive (e.g., magnetic hard disk drive), or the like, wholly or in any combination.

The computing device 120 may be configured to perform the methods 400, 500, 600, and 700 described above. For example, the computing device 120 may be configured to receive operation data observed from a fleet of vehicles. The computing device 120 is further configured to establish a first conjugate prior or a second conjugate prior for a first distribution probability density function. The computing device 120 is further configured to perform, based on the operation data and the first and second conjugate priors for the first distribution probability density function, a Maximum A Posteriori (MAP) estimation to determine distribution parameters for the first distribution probability density function, wherein the operations data are samples of the fleet indicators as well as samples of the possible outcomes of the probability distribution. The computing device 120 is further configured to predict based on the plurality of distribution parameters a probability of observing an indicator for the fleet of vehicles.

Other aspects include a computing device including a hardware processor and a memory, the memory containing instructions executable by the hardware processor whereby the computing device is configured to perform any of the methods disclosed herein.

Other aspects include a non-transitory computer-readable medium (e.g., the memory circuitry 830) storing a computer program product (e.g., software instructions 840) that includes software instructions that, when run on processing circuitry 810 of the computing device 120, causes the computing device 120 to perform any of the methods disclosed herein.

In some examples, the aspects disclosed herein apply to a fleet management system 100 that monitors vehicle 101. The vehicle fleet 110 can include a variety of different vehicles 101 including but are not limited to manned aircraft, unmanned aircraft, manned spacecraft, unmanned spacecraft, manned rotorcraft, unmanned rotorcraft, satellites, rockets, missiles, manned terrestrial vehicles, unmanned terrestrial vehicles, manned surface water borne vehicles, unmanned surface water borne vehicles, manned sub-surface water borne vehicles, unmanned sub-surface water borne vehicles, and combinations thereof.

Further, the disclosure comprises examples according to the following clauses:

Clause 1. A method of scheduling maintenance for a collection of machines, comprising: receiving operation data observed from the collection of machines wherein the operation data characterizes one or more aspects of operation of at least one machine of the collection of machines; establishing a first conjugate prior or a second conjugate prior for a first distribution probability density function; performing, based on the operation data and the first and second conjugate priors for the first distribution probability density function, a Maximum A Posteriori (MAP) estimation to determine distribution parameters for the first distribution probability density function, wherein the data are samples of the key performance indicator; responsive to performing the MAP estimation, predict, based on the distribution parameters, a probability the key performance indicator will take a value for a number of the machines; and responsive to the prediction, scheduling maintenance for the machines based on the probability.

Clause 2. The method of clause 1 wherein the first distribution probability density function is defined within a generalized-gamma distribution family; and applying a Bayesian interference to the first distribution probability density function when a gamma shape distribution parameter is unknown.

Clause 3. The method of clause 2, wherein the first conjugate prior satisfies the following relation with (μ, δ) hyperparameters:

$$p ( α \vert δ , μ , β ) ∝ \frac{{( β μ )}^{δ α}}{{Γ ( α )}^{δ}}$$

Clause 4. The method of any of clause 1, wherein the first distribution probability density function is defined within a generalized-gamma distribution family; and applying a Bayesian interference to the first distribution probability density function when a gamma shape distribution parameter is unknown and a gamma rate distribution parameter is unknown.

Clause 5. The method of clause 4, wherein the second conjugate prior satisfies the following relation with (δ, η, μ) hyperparameters:

$$p ( α , β \vert δ , η , μ ) ∝ \frac{{( β μ )}^{δ α}}{{e}^{{δ}_{η} β} {Γ ( α )}^{δ}}$$

Clause 6. The method of any of clauses 1 to 5, wherein the operation data is collected in real-time during a commercial aircraft flight operation, a military aircraft maintenance procedure, a military aircraft flight operation, or during a commercial aircraft maintenance procedure.

Clause 7. The method of any of clauses 1 to 6, wherein the first distribution probability density function is a generalized-gamma distribution function including but not limited to gamma, inverse-gamma, or Nakagami distribution function.

Clause 8. The method of any of clauses 1 to 6, wherein the first distribution probability density function is an Erlang distribution function.

Clause 9. The method of any of clauses 1 to 6, wherein the first distribution probability density function is selected from the group consisting of a chi or chi-squared distribution function.

Clause 10. The method of any of clauses 1 to 9 wherein the operation data are safety or performance related.

Clause 11. The method of any of clauses 1 to 10, wherein the event is a failure of a component of a machine or inefficient operation of the machine.

Clause 12. The method of any of clauses 1 to 11, wherein the operation data characterize utilization of each of the machines, reliability of each of the machines, hours of operation of each of the machines, or fuel or power usage of each of the machines.

Clause 13. The method of any of clauses 1 to 12, wherein the operation data indicate a deterioration in the performance of the machines.

Clause 14. The method of clause 13, wherein the operation data indicate increasing vibrations sensed in the machines, or increasing fuel or power usage.

Clause 15. The method of any of clauses 1 to 14, wherein the operation data are provided by sensors of the machines.

Clause 16. The method of clause 15, wherein the sensors are health and usage monitoring sensors.

Clause 17. The method of clause 15 or 16, wherein the sensors are strain sensors, vibration sensors, impact sensors, wear sensors, or corrosion sensors.

Clause 18. The method of any of clauses 1 to 17, wherein the maintenance comprises any of inspection of the machine, repair of the machine, or retirement of the machine.

Clause 19. The method of any of clauses 1 to 18, wherein the machines scheduled for maintenance are prioritized according to by how much the indicator exceeds the threshold.

Clause 20. The method of any of clauses 1 to 19, wherein the collection of machines is a fleet of vehicles.

Clause 21. The method of clause 20, wherein the operation data characterize the distance traveled by each of the vehicles and/or the flight hours completed by each of the vehicles.

Clause 22. The method of clause 20 or 21, wherein the fleet of vehicles is a fleet of aircraft.

Clause 23. A method of maintaining a collection of machines comprising: the method of scheduling maintenance of any of clauses 1 to 22; and maintaining the collection of machines according to the schedule.

Clause 24. A computing device comprising a hardware processor and a memory, the memory containing computer program instructions that, when executed by the hardware processor, cause the computing device to perform the method of any of clauses 1 to 22.

Clause 25. A computer program comprising computer program instructions that, when executed by a one or more hardware processors of a computing device, cause the computing device to perform the method of any of clauses 1 to 22.

Clause 26. A non-transitory computer-readable medium having stored thereon the computer program of clause 25.

Clause 27. A method comprising: receiving operation data about a collection of machines wherein the operation data characterizes one or more aspects of operation of at least one machine of the collection of machines; establishing a first conjugate prior or a second conjugate prior for a first distribution probability density function; performing, based on the operation data and the first and second conjugate priors for the first distribution probability density function, a Maximum A Posteriori (MAP) estimation to determine distribution parameters for the first distribution probability density function, wherein the data are samples of the key performance indicator; responsive to performing the MAP estimation, predict, based on the distribution parameters, a probability the key performance indicator will take a value for a number of the machines; and responsive to the prediction, scheduling maintenance for the machines based on the probability.

Clause 28. The method of clause 27 wherein the first distribution probability density function is defined within a generalized-gamma distribution family; and applying a Bayesian interference to the first distribution probability density function when a gamma shape distribution parameter is unknown.

Clause 29. The method of clause 28, wherein the first conjugate prior satisfies the following relation with (μ, δ) hyperparameters:

$$p ( α \vert δ , μ , β ) ∝ \frac{{( β μ )}^{δ α}}{{Γ ( α )}^{δ}}$$

Clause 30. The method of clause 27, wherein the first distribution probability density function is defined within a generalized-gamma distribution family; and applying a Bayesian interference to the first distribution probability density function when a gamma shape distribution parameter is unknown and a gamma rate distribution parameter is unknown.

Clause 31. The method of clause 30, wherein the second conjugate prior satisfies the following relation with (δ, η, μ) hyperparameters:

$$p ( α , β \vert δ , η , μ ) ∝ \frac{{( β μ )}^{δ α}}{{e}^{{δ}_{η} β} {Γ ( α )}^{δ}}$$

Clause 32. The method of clause 27, wherein the operation data is collected in real-time during a commercial aircraft flight operation, a military aircraft maintenance procedure, a military aircraft flight operation, or during a commercial aircraft maintenance procedure.

Clause 33. The method of clause 27, wherein the first distribution probability density function is a generalized-gamma distribution function including but not limited to gamma, inverse-gamma, or Nakagami distribution function.

Clause 34. The method of clause 27, wherein the first distribution probability density function is an Erlang distribution function.

Clause 35. The method of clause 27, wherein the first distribution probability density function is selected from the group consisting of a chi or chi-squared distribution function.

Clause 36. The method of clause 27, wherein the indicator is a beginning of a wear-out life phase for a fleet vehicle in a fleet of vehicles.

Clause 37. A computing device comprising: a hardware processor and a memory, the memory containing instructions executable by the hardware processor whereby the computing device is configured to: receive operation data about a collection of machines wherein the operation data characterizes one or more aspects of operation of at least one machine of the collection of machines; responsive to receiving operation data, establish a first conjugate prior or a second conjugate prior for a first distribution probability density function; responsive to the establishing, perform, based on the operation data and the first and second conjugate priors for the first distribution probability density function, a Maximum A Posteriori (MAP) estimation to determine distribution parameters for the first distribution probability density function, wherein the data are samples of the key performance indicator responsive to performing the MAP estimation, predict, based on the distribution parameters, the probability of the event associated with the indicator occurring for each of the machines; and responsive to predicting the probability, schedule maintenance for the machines having a probability of the event associated with the indicator that exceeds a threshold.

Clause 38. The computing device of clause 37, wherein the first distribution probability density function is defined within a generalized-gamma distribution family and applying a Bayesian interference to the first distribution probability density function when a gamma shape distribution parameter is unknown.

Clause 39. The computing device of clause 37, wherein the first conjugate prior satisfies the following relation with (δ, μ) hyperparameters:

$$p ( α \vert δ , μ , β ) ∝ \frac{{( β μ )}^{δ α}}{{Γ ( α )}^{δ}}$$

Clause 40. The computing device of clause 37, wherein the first distribution probability density function is defined within a generalized-gamma distribution family, and a Bayesian interference is applied to the first distribution probability density function when a shape distribution parameter is unknown and a rate distribution parameter is unknown.

Clause 41. The computing device of clause 40, wherein the second conjugate prior satisfies the following relation with (δ, η, μ) hyperparameters:

$$p ( α , β \vert δ , η , μ ) ∝ \frac{{( β μ )}^{δ α}}{{e}^{{δ}_{η} β} {Γ ( α )}^{δ}}$$

Clause 42. The computing device of clause 37, wherein the operation data is collected in real-time during a commercial aircraft flight operation, a military aircraft maintenance procedure, a military aircraft flight operation, or during a commercial aircraft maintenance procedure.

Clause 43. The computing device of clause 37, wherein the first distribution probability density function is a generalized-gamma distribution function including but not limited to gamma, inverse-gamma, or Nakagami distribution function.

Clause 44. The computing device of clause 37, wherein the first distribution probability density function is an Erlang distribution function.

Clause 45. The computing device of clause 37, wherein the first distribution probability density function is selected from a group consisting of a chi or chi-squared distribution function.

Clause 46. A non-transitory computer-readable medium storing a computer program product, the computer program product comprising software instructions that, when run on a computing device, cause the computing device to: receive operation data about a collection of machines wherein the operation data characterizes one or more aspects of operation of at least one machine of the collection of machines; establish a first conjugate prior or a second conjugate prior for a first distribution probability density function; perform, based on the operation data and the first and second conjugate priors for the first distribution probability density function, a Maximum A Posteriori (MAP) estimation to determine distribution parameters for the first distribution probability density function, wherein the data are samples of the key performance indicator; responsive to performing the MAP estimation, predict, based on the distribution parameters, a probability the key performance indicator will take a value for a number of the machines; and responsive to the prediction, scheduling maintenance for the machines based on the probability.

Clause 47. A method comprising, receiving operation data about a collection of machines wherein the operation data characterizes one or more aspects of operation of at least one machine of the collection of machines; establishing a first conjugate prior or a second conjugate prior for a first distribution probability density function; performing, based on the operation data and the first and second conjugate priors for the first distribution probability density function, a Maximum A Posteriori (MAP) estimation to determine distribution parameters for the first distribution probability density function, wherein the data are samples of the key performance indicator; predicting, based on the distribution parameters, a probability the key performance indicator will take a value for a number of the machines; and scheduling maintenance for the machines based on the probability.

Clause 48. The method of clause 47 wherein the first distribution probability density function is defined within a generalized-gamma distribution family; and applying a Bayesian interference to the first distribution probability density function when a gamma shape distribution parameter is unknown.

Clause 49. The method of clause 48, wherein the first conjugate prior satisfies the following relation with (μ, δ) hyperparameters:

$$p ( α \vert δ , μ , β ) ∝ \frac{{( β μ )}^{δ α}}{{Γ ( α )}^{δ}}$$

Clause 50. The method of clause 47, wherein the first distribution probability density function is defined within a generalized-gamma distribution family; and applying a Bayesian interference to the first distribution probability density function when a gamma shape distribution parameter is unknown and a gamma rate distribution parameter is unknown.

Clause 51. The method of clause 50, wherein the second conjugate prior satisfies the following relation with (δ, η, μ) hyperparameters:

$$p ( α , β \vert δ , η , μ ) ∝ \frac{{( β μ )}^{δ α}}{{e}^{{δ}_{η} β} {Γ ( α )}^{δ}}$$

Clause 52. The method of clause 47, wherein the operation data is collected in real-time during a commercial aircraft flight operation, a military aircraft maintenance procedure, a military aircraft flight operation, or during a commercial aircraft maintenance procedure.

Clause 53. The method of clause 47, wherein the first distribution probability density function is a generalized-gamma distribution function including but not limited to gamma, inverse-gamma, or Nakagami distribution function.

Clause 54. The method of clause 47, wherein the first distribution probability density

function is an Erlang distribution function.

Clause 55. The method of clause 47, wherein the first distribution probability density function is selected from the group consisting of a chi or chi-squared distribution function.

Clause 56. The method of clause 47, wherein the indicator is a repair time to fix a component of the machines.

Clause 57. A computing device comprising: a hardware processor and a memory, the memory containing instructions executable by the hardware processor whereby the computing device is configured to: receive operation data about a collection of machines wherein the operation data characterizes one or more aspects of operation of at least one machine of the collection of machines; responsive to receiving operation data, establish a first conjugate prior or a second conjugate prior for a first distribution probability density function; responsive to the establishing, perform, based on the operation data and the first and second conjugate priors for the first distribution probability density function, a Maximum A Posteriori (MAP) estimation to determine distribution parameters for the first distribution probability density function, wherein the operation data are samples of the key performance indicator; responsive to performing the MAP estimation, predict, based on the distribution parameters, a probability the key performance indicator will take a value for a number of the machines; and responsive to predicting the probability, scheduling maintenance for the machines based on the probability.

Clause 58. The computing device of clause 57, wherein the first distribution probability density function is defined within a generalized-gamma distribution family and applying a Bayesian interference to the first distribution probability density function when a gamma shape distribution parameter is unknown.

Clause 59. The computing device of clause 58, wherein the first conjugate prior satisfies the following relation with (δ, μ) hyperparameters:

$$p ( α \vert δ , μ , β ) ∝ \frac{{( β μ )}^{δ α}}{{Γ ( α )}^{δ}}$$

Clause 60. The computing device of clause 57, wherein the first distribution probability density function is defined within a generalized-gamma distribution family, and a Bayesian interference is applied to the first distribution probability density function when a shape distribution parameter is unknown and a rate distribution parameter is unknown.

Clause 61. The computing device of clause 60, wherein the second conjugate prior satisfies the following relation with (δ, η, μ) hyperparameters:

$$p ( α , β \vert δ , η , μ ) ∝ \frac{{( β μ )}^{δ α}}{{e}^{{δ}_{η} β} {Γ ( α )}^{δ}}$$

Clause 62. The computing device of clause 57, wherein the operation data is collected in real-time during a commercial aircraft flight operation, a military aircraft maintenance procedure, a military aircraft flight operation, or during a commercial aircraft maintenance procedure.

Clause 63. The computing device of clause 57, wherein the first distribution probability density function is a generalized-gamma distribution function including but not limited to gamma, inverse-gamma, or Nakagami distribution function.

Clause 64. The computing device of clause 57, wherein the first distribution probability density function is an Erlang distribution function.

Clause 65. The computing device of clause 57, wherein the first distribution probability density function is selected from a group consisting of a chi or chi-squared distribution function.

Clause 66. A non-transitory computer-readable medium storing a computer program product, the computer program product comprising software instructions that, when run on a computing device, cause the computing device to: receive operation data about a collection of machines wherein the operation data characterizes one or more aspects of operation of at least one machine of the collection of machines; establish a first conjugate prior or a second conjugate prior for a first distribution probability density function; perform, based on the operation data and the first and second conjugate priors for the first distribution probability density function, a Maximum A Posteriori (MAP) estimation to determine distribution parameters for the first distribution probability density function, wherein the operation data are samples of the key performance indicator; responsive to performing the MAP estimation, predict, based on the distribution parameters, a probability the key performance indicator will take a value for a number of the machines; and responsive to the prediction, scheduling maintenance for the machines based on the probability.

These aspects can also be used in other contexts than fleet management. For example, distributions may be used in radio telecommunications, finance, healthcare, and various other applications.

The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various sequences and orders while still falling within the scope of the present disclosure.

What is claimed is:

1. A method comprising:
receiving operation data about a collection of machines wherein the operation data characterizes one or more aspects of operation of at least one machine of the collection of machines;
establishing a first conjugate prior or a second conjugate prior for a first distribution probability density function;
performing, based on the operation data and the first and second conjugate priors for the first distribution probability density function, a Maximum A Posteriori (MAP) estimation to determine distribution parameters for the first distribution probability density function, wherein the data are samples of the key performance indicator;
predicting, based on the distribution parameters, a probability the key performance indicator will take a value for a number of the machines; and
scheduling maintenance for the machines based on the probability.

2. The method of claim 1 wherein the first distribution probability density function is defined within a generalized-gamma distribution family; and applying a Bayesian interference to the first distribution probability density function when a gamma shape distribution parameter is unknown.

3. The method of claim 2, wherein the first conjugate prior satisfies the following relation with (μ, δ) hyperparameters:
$$p ( α \vert δ , μ , β ) ∝ \frac{{( β μ )}^{δ α}}{{Γ ( α )}^{δ}}$$

4. The method of claim 1, wherein the first distribution probability density function is defined within a generalized-gamma distribution family; and applying a Bayesian interference to the first distribution probability density function when a gamma shape distribution parameter is unknown and a gamma rate distribution parameter is unknown.

5. The method of claim 4, wherein the second conjugate prior satisfies the following relation with (δ, η, μ) hyperparameters:
$$p ( α , β \vert δ , η , μ ) ∝ \frac{{( β μ )}^{δ α}}{{e}^{{δ}_{η} β} {Γ ( α )}^{δ}}$$

6. The method of claim 1, wherein the operation data is collected in real-time during a commercial aircraft flight operation, a military aircraft maintenance procedure, a military aircraft flight operation, or during a commercial aircraft maintenance procedure.

7. The method of claim 1, wherein the first distribution probability density function is a generalized-gamma distribution function including but not limited to gamma, inverse-gamma, or Nakagami distribution function.

8. The method of claim 1, wherein the first distribution probability density function is an Erlang distribution function.

9. The method of claim 1, wherein the first distribution probability density function is selected from the group consisting of a chi or chi-squared distribution function.

10. The method of claim 1, wherein the indicator is a repair time to fix a component of the machines.

11. A computing device comprising:
a hardware processor and a memory, the memory containing instructions executable by the hardware processor whereby the computing device is configured to:
receive operation data about a collection of machines wherein the operation data characterizes one or more aspects of operation of at least one machine of the collection of machines;
responsive to receiving operation data, establish a first conjugate prior or a second conjugate prior for a first distribution probability density function;
responsive to the establishing, perform, based on the operation data and the first and second conjugate priors for the first distribution probability density function, a Maximum A Posteriori (MAP) estimation to determine distribution parameters for the first distribution probability density function, wherein the operation data are samples of the key performance indicator;
responsive to performing the MAP estimation, predict, based on the distribution parameters, a probability the key performance indicator will take a value for a number of the machines; and
responsive to predicting the probability, scheduling maintenance for the machines based on the probability.

12. The computing device of claim 11, wherein the first distribution probability density function is defined within a generalized-gamma distribution family and applying a Bayesian interference to the first distribution probability density function when a gamma shape distribution parameter is unknown.

13. The computing device of claim 11, wherein the first conjugate prior satisfies the following relation with (δ, μ) hyperparameters:
$$p ( α \vert δ , μ , β ) ∝ \frac{{( β μ )}^{δ α}}{{Γ ( α )}^{δ}}$$

14. The computing device of claim 11, wherein the first distribution probability density function is defined within a generalized-gamma distribution family, and a Bayesian interference is applied to the first distribution probability density function when a shape distribution parameter is unknown and a rate distribution parameter is unknown.

15. The computing device of claim 14, wherein the second conjugate prior satisfies the following relation with (δ, η, μ) hyperparameters:
$$p ( α , β \vert δ , η , μ ) ∝ \frac{{( β μ )}^{δ α}}{{e}^{{δ}_{η} β} {Γ ( α )}^{δ}}$$

16. The computing device of claim 11, wherein the operation data is collected in real-time during a commercial aircraft flight operation, a military aircraft maintenance procedure, a military aircraft flight operation, or during a commercial aircraft maintenance procedure.

17. The computing device of claim 11, wherein the first distribution probability density function is a generalized-gamma distribution function including but not limited to gamma, inverse-gamma, or Nakagami distribution function.

18. The computing device of claim 11, wherein the first distribution probability density function is an Erlang distribution function.

19. The computing device of claim 11, wherein the first distribution probability density function is selected from a group consisting of a chi or chi-squared distribution function.

20. A non-transitory computer-readable medium storing a computer program product, the computer program product comprising software instructions that, when run on a computing device, cause the computing device to:
receive operation data about a collection of machines wherein the operation data characterizes one or more aspects of operation of at least one machine of the collection of machines;
establish a first conjugate prior or a second conjugate prior for a first distribution probability density function;
perform, based on the operation data and the first and second conjugate priors for the first distribution probability density function, a Maximum A Posteriori (MAP) estimation to determine distribution parameters for the first distribution probability density function, wherein the operation data are samples of the key performance indicator;
responsive to performing the MAP estimation, predict, based on the distribution parameters, a probability the key performance indicator will take a value for a number of the machines;
and responsive to the prediction, scheduling maintenance for the machines based on the probability.
